(19) United States
(12) Patent Application Publication
(10) Pub. No.: US 2021/0069065 A1
(43) Pub. Date: Mar. 11, 2021

(54) PILL CUP ASSEMBLY

(71) Applicant: First Wave Products Group, LLC, Batavia, NY (US)

(72) Inventors: Brian D. Bell, Wyoming, NY (US); Douglas Dufaux, Orchard Park, NY (US)

(21) Appl. No.: 17/014,165

(22) Filed: Sep. 8, 2020

Related U.S. Application Data
(60) Provisional application No. 62/896,957, filed on Sep. 6, 2019.

(51) Int. Cl. A61J 7/00

(52) U.S. Cl. CPC A61J 7/0007

(57) ABSTRACT

A pill cup assembly with first and second nestable cups where the first cup includes a flange extending from the upper perimeter edge and terminating in a free edge, the flange extending in a downward direction and spaced from the cup side wall and wherein the first cup is nestable within the second cup with the flange free edge locating within said second cup interior space when placed in the nested condition. The flange free edge contacts and forms a 360° barrier with the second cup to prevent pill material from escaping from between the cups.

### BACKGROUND OF THE INVENTION

The present invention relates to pill crushing systems, and more particularly relates to nestable cups having improved pill crushing features and interfacing dimensions which inhibit migration and escape of the powdered pill material from between the cups.

The grinding or crushing of pills into powder form may be necessary when, for example, the person has trouble swallowing whole pills due to throat problems. This is a common need in nursing homes and hospitals. While the very first pill crushing device was most likely the mortar and pestle (which is still used today), more technologically advanced pill crushing devices have been developed over the years (manually or electrically driven) which have various designs that offer advantages over the mortar and pestle, such as making the pill crushing operation quicker, easier and safer (e.g., by preventing cross-contamination between different Rx pills ground in succession), for example.

Some pill crushing devices utilize a pair of disposable cups which may be nested together with the pill located therebetween. As one cup is rotated relative to the other cup, the pill is ground into a powder. The top cup is removed, leaving the powdered pill inside the bottom cup. An additive such as juice or applesauce, for example, may be added to the cup and mixed with the powder to form a liquid or slurry which the patient may more easily swallow. An example of such a nested cup pill crushing device may be seen in commonly owned U.S. Pat. No. 9,717,651.

### SUMMARY OF THE INVENTION

The present invention provides a pair of nestable cups wherein the bottom cup and top cup are cooperatively configured to promote improved pill crushing and cup handling and inhibit powder migration and escape from between the cups. The respective cup dimensions are selected so as to cause more pronounced migration of the pill particles in a radially outward direction along the facing cup walls. Radial and even migration of the pill particles between the cups is desirable in that the more cup surface area that is actively grinding against the pill particles, the more pill particles will be subject to continuous grinding which results in a finer (smaller) resultant particle size. The finer the resultant powder, the better the powder will mix with the liquid food additive which will be easier to swallow for the patient than a mixture having larger pill particles therein. Furthermore, since the interfacing geometries of the nested cup side walls are such as to inhibit the fine powder from reaching the open top perimeters of the cups, the full amount of finely powdered pill material stays between the cups, and within the bottom cup.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1 is an elevational view of the bottom and top cups in spaced relation to each other;

FIG. 2 is a perspective view thereof with the cups fragmented;

FIG. 3 is a back elevational view of the bottom and top cups in the nested position;

FIG. 4 is a front elevational view of the bottom and top cups in the nested position;

FIG. 5 is a right side elevational view of the bottom and top cups in the nested position;

FIG. 6 is a left side elevational view of the bottom and top cups in the nested position;

FIG. 7 is a bottom plan view of the nested cups;

FIG. 8 is a top plan view of the nested cups;

FIG. 9 is a perspective view of the unassembled cups;

FIG. 10 is a cross sectional view of the nested cups;

FIG. 11 is a perspective view of the nested cups;

FIG. 12A is a cross section view of the cups placed in contacting relation referred to herein as “the initially engaged position”;

FIG. 12B is the view of FIG. 12A with the top cup positioned further into the bottom cup referred to herein as “the substantially nested position”;

FIGS. 13A and 13B are fragmented cross sectional views of an embodiment of the invention shown in the initially engaged and substantially nested positions respectively;

FIGS. 14A and 14B are fragmented cross sectional views of another embodiment of the invention shown in the initially engaged and substantially nested positions respectively;

FIGS. 15A and 15B are fragmented cross sectional views of another embodiment of the invention shown in the initially engaged and substantially nested positions, respectively;

FIGS. 16A and 16B are top plan and side elevational views of the top cup showing an embodiment with dimension lines, respectively;

FIGS. 17A and 17B are top plan and side elevational views of the top cup showing an embodiment with dimension lines, respectively;

FIG. 18 is a fragmented perspective view of another embodiment of the top cup;

FIG. 19 is an elevational cross section view of an alternative embodiment of bottom and top cups, shown in spaced relation to each other;

FIG. 20 is a perspective view of the unassembled alternative embodiment of cups shown in FIG. 19; and

FIG. 21 is a perspective view of the unassembled alternative embodiment of cups shown in FIGS. 19 and 20 with the cups fragmented.

### DETAILED DESCRIPTION OF A PREFERRED EMBODIMENT

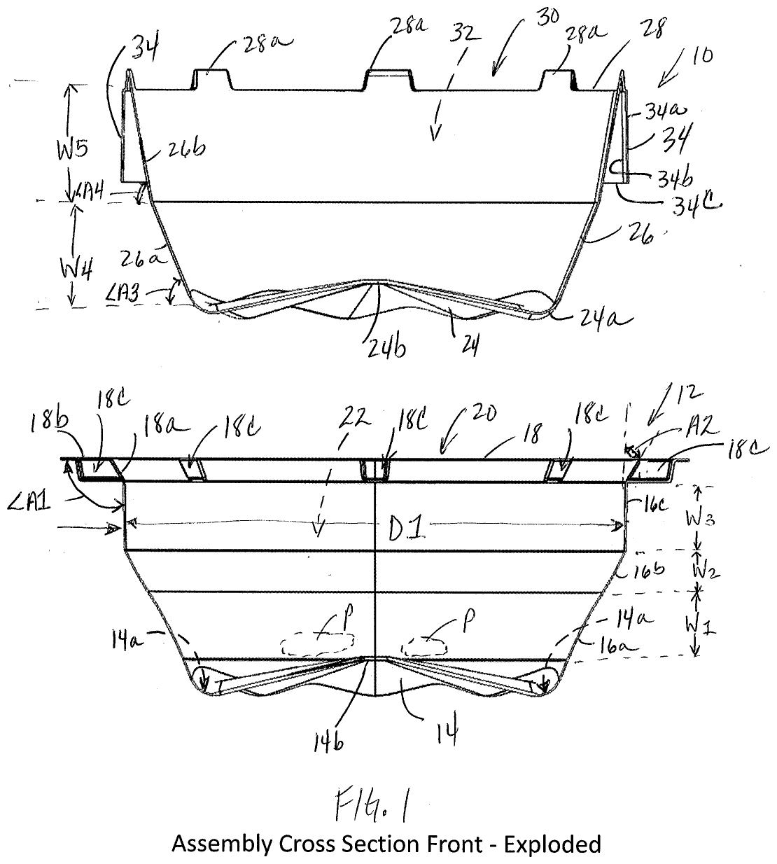

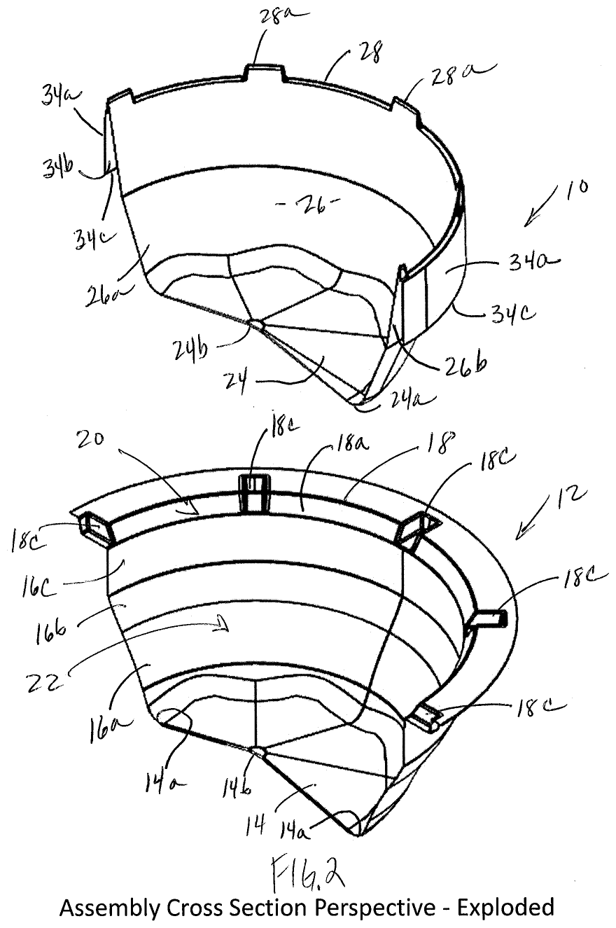

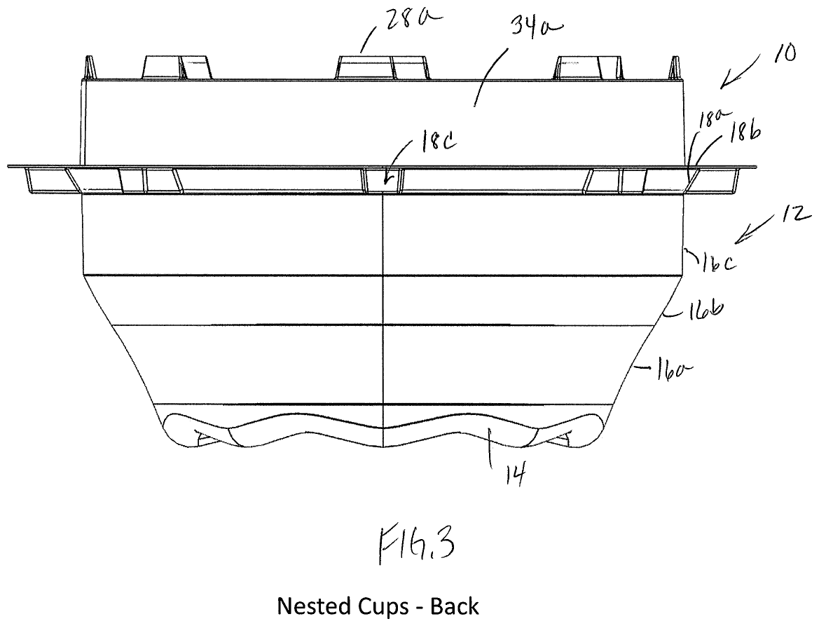

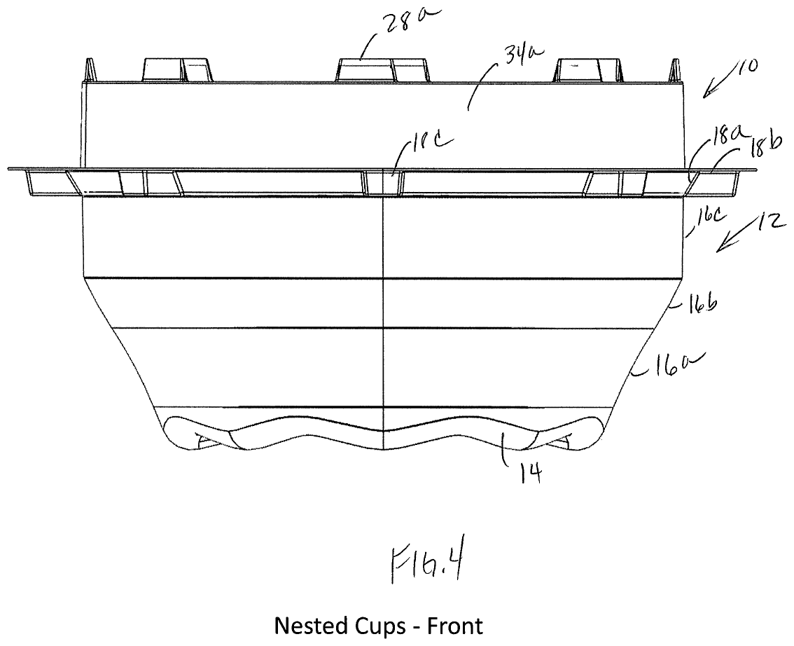

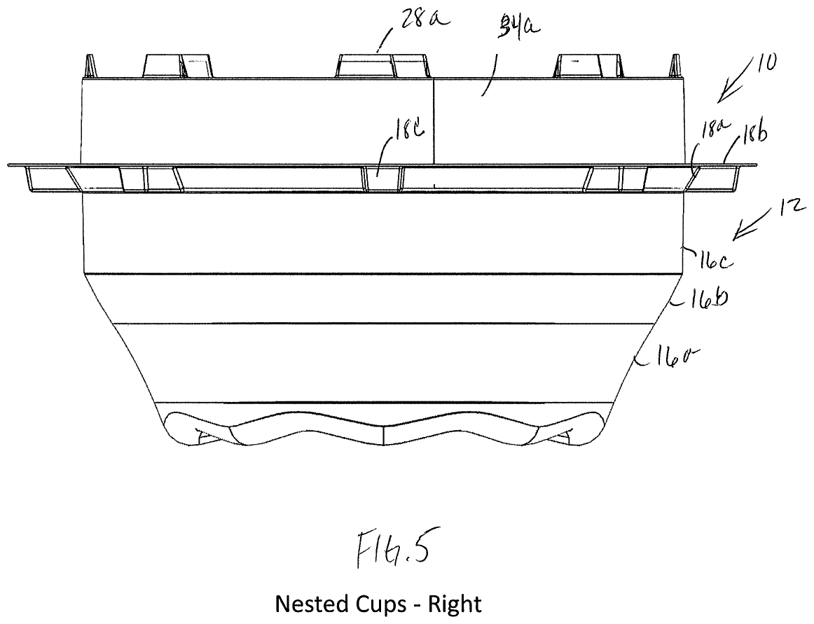

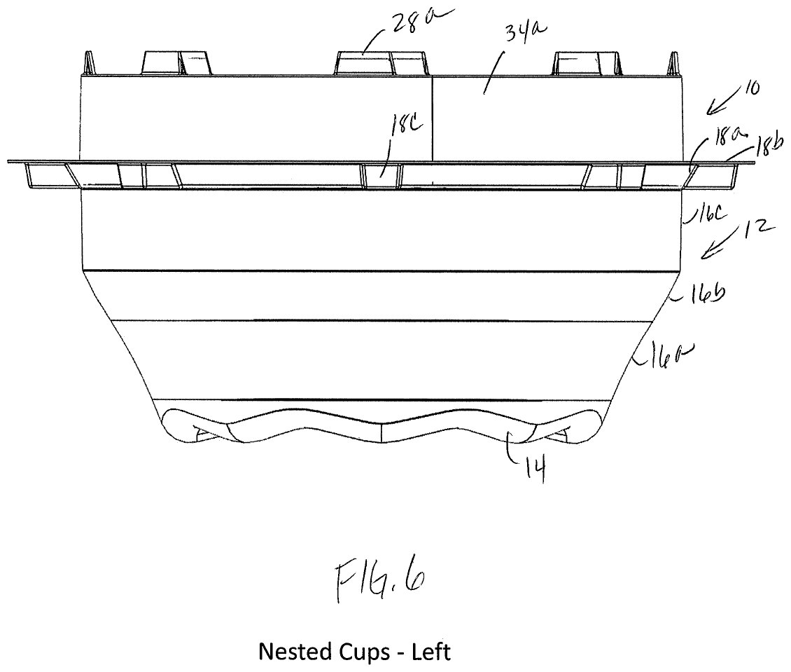

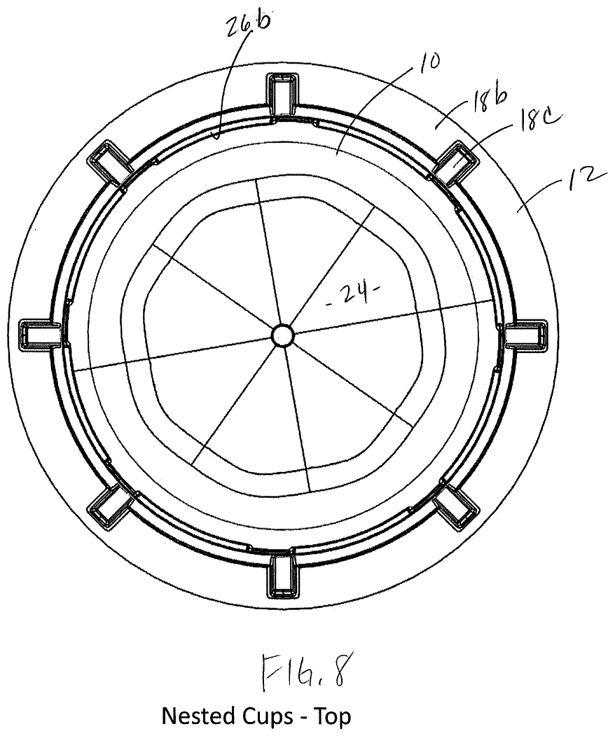

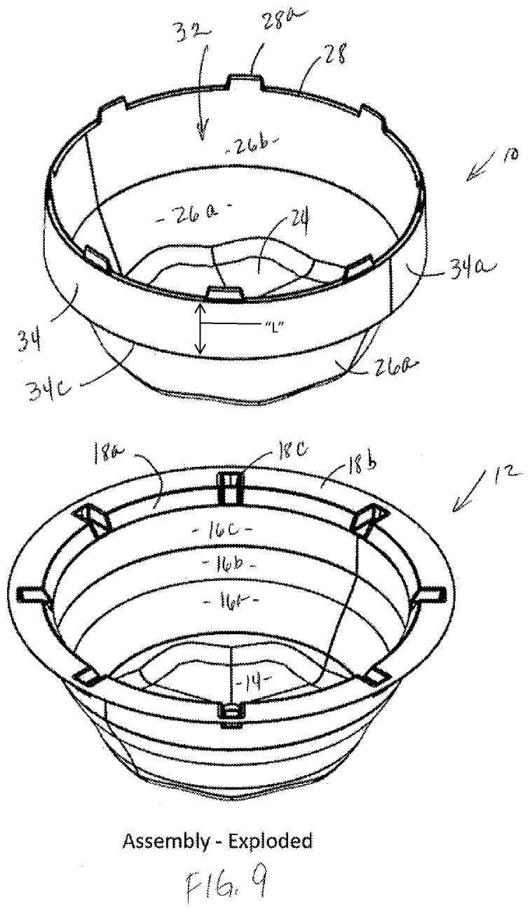

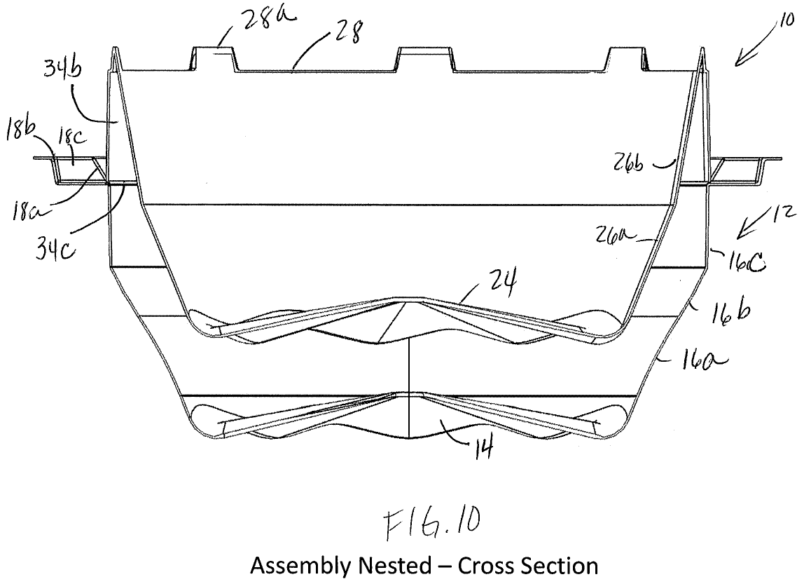

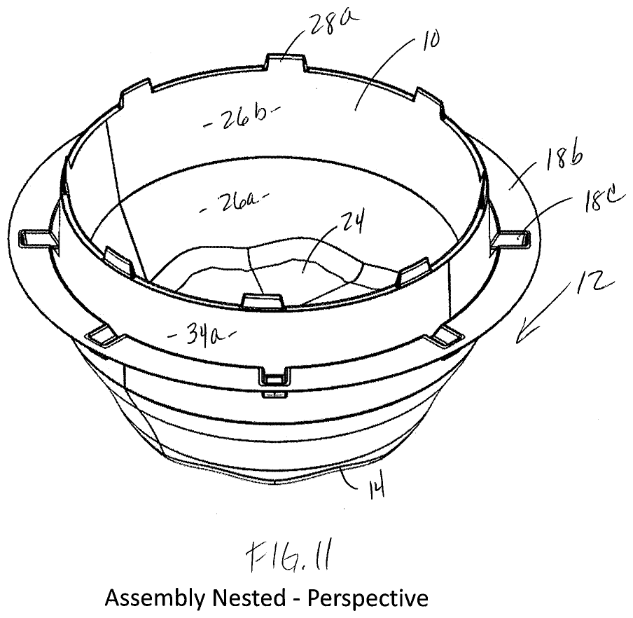

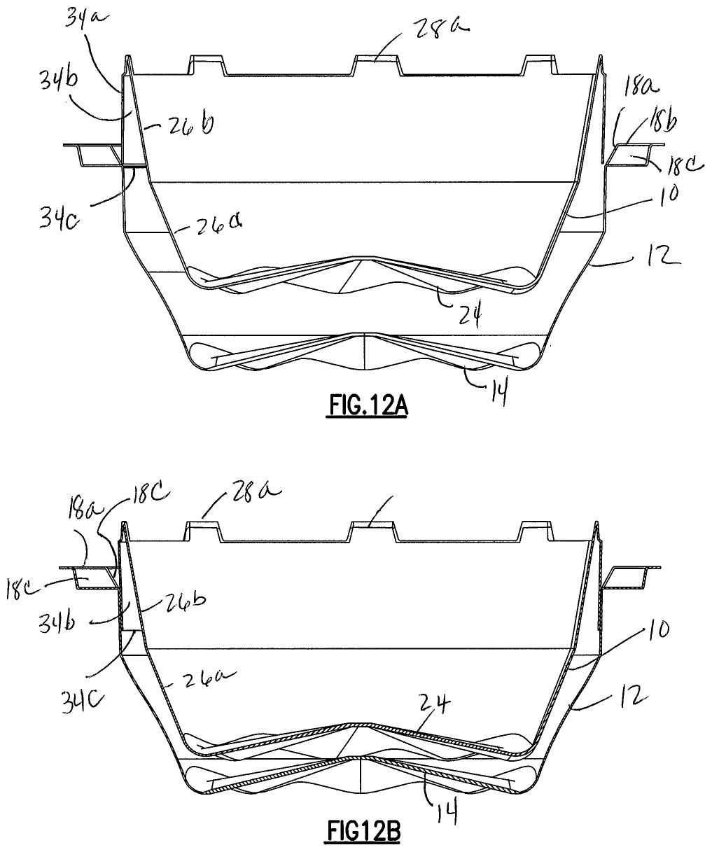

Referring now to the drawings, with particular reference to FIGS. 1-18, there is seen nestable top and bottom cups 10 and 12, respectively, for crushing one or more pills “P” placed therebetween .The pair of nestable cups 10 and 12 may be used manually but are preferably used with a pill crushing machine in which the cups may be removably placed with the machine operable to rotate one of the cups relative to the other cup to impart a grinding force on the one or more pills located therebetween. Cups 10, 12 are preferably disposable single use cups and formed of a suitable material such as metal or plastic, for example, which may be vacuum or thermo formed plastic, for example.

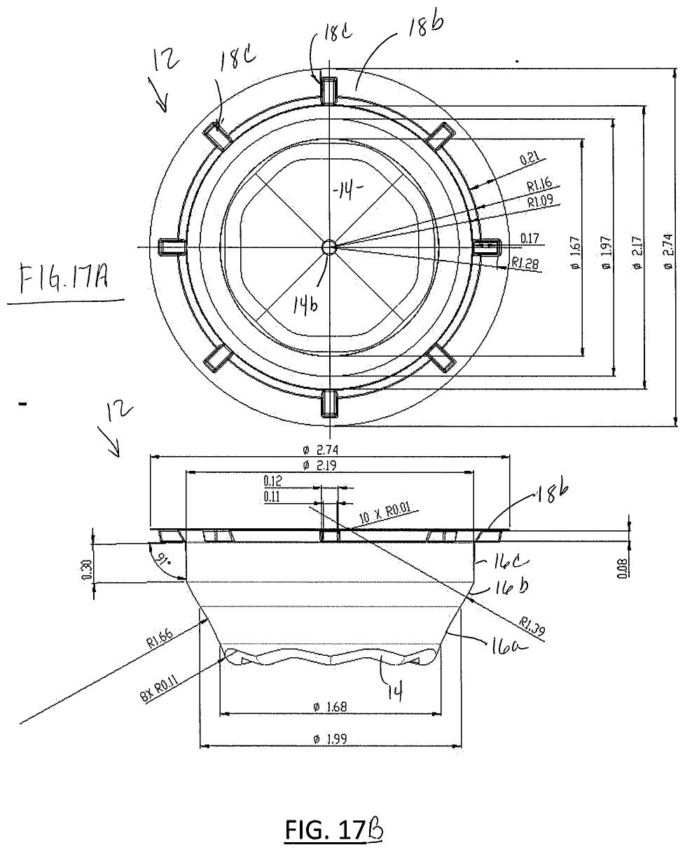

In a preferred embodiment shown (FIGS. 1-17), top cup 10 and bottom cup 12 have different dimensions, with top cup 10 being generally smaller than bottom cup 12. In one preferred embodiment, the top and bottom cups 10 and 12 have the dimensions the same or about the same as the dimensions seen in FIGS. 16A, 16B and FIGS. 17A, 17B, which dimension are provided in inches.

Referring first to bottom cup 12, bottom cup 12 includes a bottom wall 14 with an integral side wall 16 extending from the bottom wall 14 and terminating in an upper perimeter 18 defining an open top 20 leading to an interior space 22.

Bottom wall 14 may have a radial fluted configuration as seen in the Figures although other configurations are possible. The radial fluted configuration promotes crushing of the pill(s) “P” between the top and bottom cups due to the interrupted surface topography. The inner perimeter 14a is preferably curved to enable the leading edge of a spoon to be easily passed thereagainst in an uninterrupted manner so as to enable easy scooping out of essentially all of the powdered pill once mixed with the food additive to form a slurry/liquid to aid ingestion as discussed above. The center section 14b may be indented toward open top 20 so that the pill material tends to collect toward the perimeter 14a.

Side wall 16 may have one or more segments 16a, 16b and 16c which may be of differing dimensions. In the embodiment shown in the Figures, a first segment 16a extends from bottom wall 14 a first width W1 and may curve inwardly as it extends in the direction toward open top 20. A second segment 16b may extend from first segment 16a and may taper outwardly for a second width W2. A third segment 16c may extend from second segment 16b and may be of substantially uniform diameter D1 along its width W3.

Upper perimeter 18 may include a tapered wall segment 18a which extends from wall segment 16c to a flange 18b. Flange 18b may be substantially planar and lie along a plane which extends at an angle “A1” relative side wall segment 16c. Tapered wall segment 18a may extend at an acute angle “A2” from side wall segment 16c. One or more recesses 18c may be formed in annularly spaced relation about upper perimeter 18 which allow bottom cup 12 to be removably held by a cup holder having complimentary shaped and spaced projections where the projections align with and may removably engage the recesses 18c.

Referring now to top cup 10, top cup 10 includes a bottom wall 24 with an integral side wall 26 extending from the bottom wall 24 and terminating in an upper perimeter 28 defining an open top 30 leading to an interior space 32.

Bottom wall 24 may have a radial fluted configuration as seen in FIGS. 1-17 although other configurations are possible. The radial fluted configuration may be of complimentary configuration to bottom cup bottom wall 14 with the outer surface of inner perimeter 24a preferably curved to closely follow the curve of the bottom cup inner perimeter 14a, and the center section 24b indented toward open top 30.

Side wall 26 may have one or more segments 26a and 26b which may be of differing dimensions. In the embodiment shown in the FIGS. 1-17, a first segment 26a extends from bottom wall 24 a width W4 and may taper outwardly as it extends in the direction toward open top 30. A second segment 26b may extend from first segment 26a and may taper outwardly for a width W5. The angle of taper “A3” of first segment 26a may be greater than the angle of taper “A4” of second segment 26b.

Upper perimeter 28 may include a flange 34 which extends from upper perimeter 28 downwardly in the general direction of bottom wall 24 and spaced outwardly of cup side wall segment 26b. Flange 34 includes an outer surface 34a, and inner surface 34b and a free edge 34c.

One or more projections 28a may be formed in annularly spaced relation about upper perimeter 28 which allow top cup 10 to be removably held by a cup holder having complimentary shaped and spaced recesses where the projections 28a may align with and may removably engage the recesses.

In one embodiment shown in FIGS. 13A and 13B, when the cups 10 and 12 are positioned in a vertically aligned “initially engaged” position, flange free edge 34c lies slightly inwardly of the upper end 16c′ of side wall segment 16c. As top cup 10 is placed into the interior space 22 of bottom cup 12, flange free edge 34c encounters the inner surface of wall segment 16c with the flange outer surface 34a sliding along inner surface 16c″ of wall segment 16c such that the facing surfaces 34a and 16c″ are in contacting relation as seen in FIG. 13B. This contacting relation which extends a full 360° around the cups creates a physical barrier preventing pill material from escaping from between the cups. In this embodiment, flange 34 may be flexible such that it bendably yields against the bottom cup inner wall segment surface 16c″ which remains substantially fixed.

It is noted that the tapered wall segment 18a of bottom cup upper perimeter 18 may act as a funnel, directing flange free edge 34c inwardly toward bottom cup interior 22, particularly should flange free edge 34c be slightly misaligned as top cup is brought close to bottom cup 12 and strike tapered wall segment 18a.

In another embodiment shown in FIGS. 14A and 14B, flange free edge 34c lies at about the same diameter as the upper end 16c′ of side wall segment 16c. The top edge 16c′ may be slightly rounded, for example, such that flange free edge 34c upon encountering top edge 16c′ will bendably yield inwardly and thus be directed inside bottom cup as top cup is advanced into bottom cup 12. In this embodiment, flange 34 may include one or more collapsible wall areas such that flange 34 will, upon receiving inward pressure from bottom wall side wall segment 16c as the top cup is advanced into the bottom cup, collapse upon itself creating a type of “wrinkle” in the wall structure, such as seen at 34d in FIG. 14B. It is understood that in any embodiment having a flange with one or more collapsible wall areas, there will always be a 360° seal formed between the flange and bottom cup wall segment 16c when top cup 10 is nested inside bottom cup 12. As in the embodiment of FIGS. 13A and 13B, tapered wall segment 18a of bottom cup upper perimeter 18 may act as a funnel, directing flange free edge 34c inwardly toward bottom cup interior 22, particularly should flange free edge 34c be slightly misaligned as top cup is brought close to bottom cup 12 and strike tapered wall segment 18a.

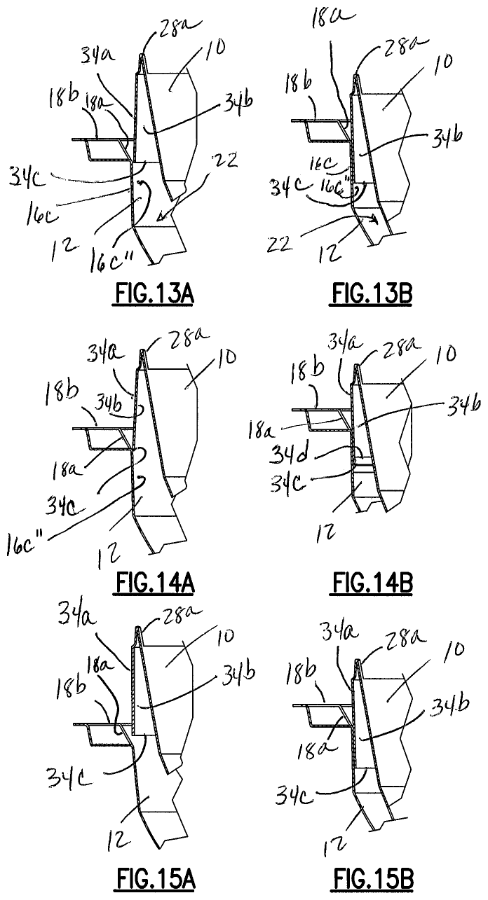

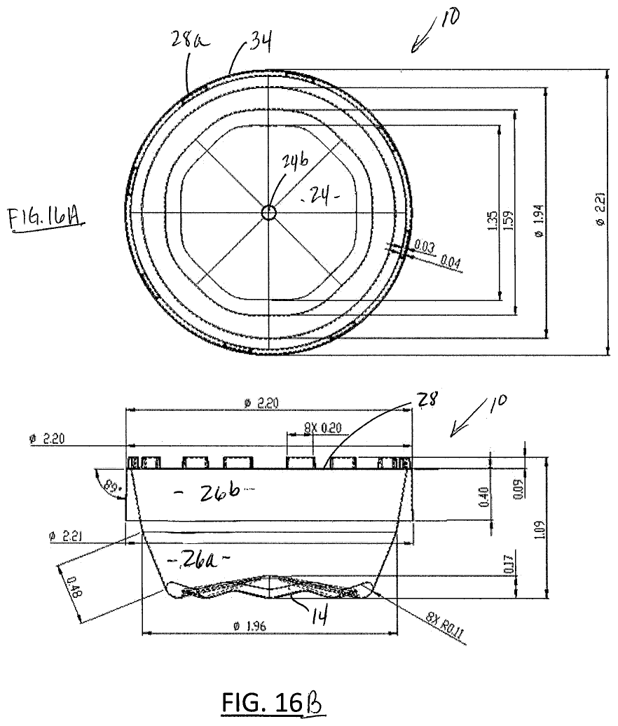

In yet another embodiment shown in FIGS. 15A and 15B, bottom side wall segment 16c is flexible while flange 34 is rigid such that bottom cup side wall segment 16c will bendably yield to flange 34 as top cup is advanced into bottom cup 12. In this embodiment, as flange free edge 34c pushes against side wall segment 16c, the lowermost part of side wall segment 16c will be pressed outwardly causing the uppermost part of segment 16c to pull inwardly and thereby create the contacting seal between flange 34 and side wall segment 16c seen in FIG. 15B.

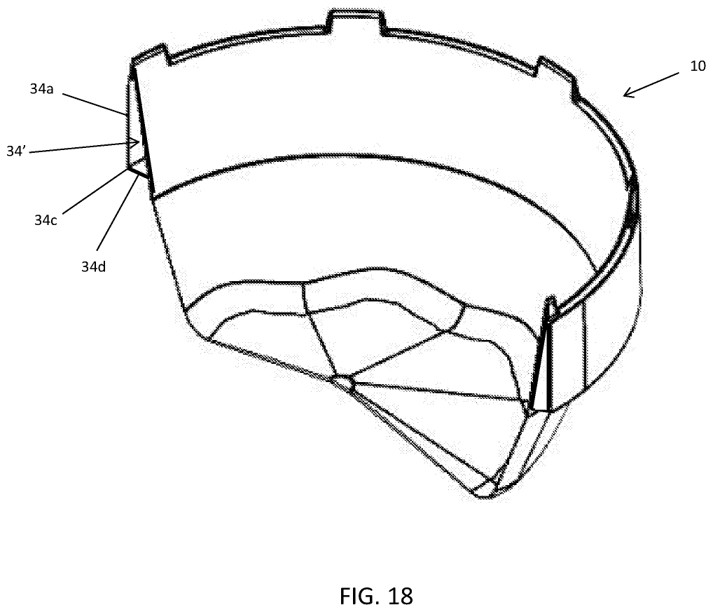

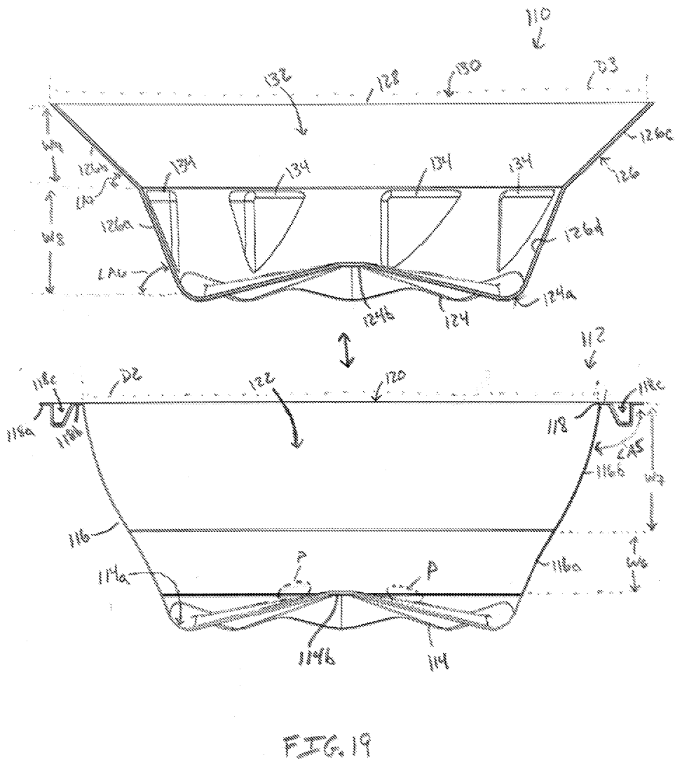

In the embodiment where flange 34 is rigid, there is no requirement for a space between flange inner surface 34b and side wall second segment 26b. As such, a shoulder 34d may extend between free edge 34c and side wall second segment 26b. Also, the area indicated by reference numeral 34′ in FIG. 18 may be hollow or solid.

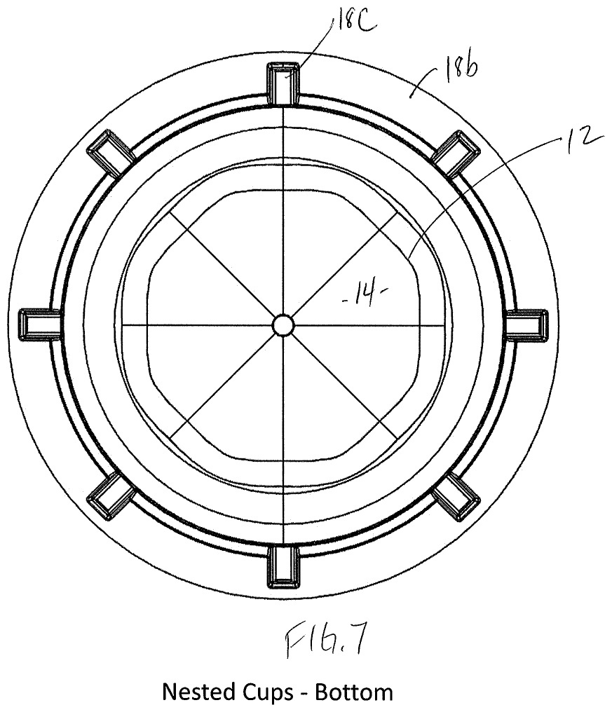

In all embodiments shown in FIGS. 1-18, the length “L” of the top cup flange 34 (see FIG. 9) is selected so that it is long enough that it makes contact with the bottom cup side wall inside surface relative to the expected height of pills in the cups (which dictates the initial distance between the facing surfaces of the bottom walls of each cup in the nested condition). Thus, for very large pills, the initial distance between the facing bottom walls of the nested cups (pre grinding) will be larger than if the pills were smaller. In this instance, the flange 34 may be made longer to ensure it engages the bottom wall inside wall surface when in the nested, pre-grinding condition.

The present invention may comprise a pill cup assembly adapted for grinding one or more pills into a powder, the pill cup assembly comprising:

a) first and second nestable cups each having a bottom wall with inner and outer surfaces and a side wall with inner and outer surfaces, each side wall extending from a respective said bottom wall and terminating in an upper perimeter edge defining an open top with an interior space;

b) a flange extending from the upper perimeter edge of the first cup, the flange having an outer wall surface and terminating in a free edge, the flange spaced from the top cup side wall;

wherein the first cup is nestable within said second cup with the flange free edge of said first cup locating within the second cup interior space when placed in the nested condition.

The pill cup assembly may include an embodiment wherein the flange free edge contacts and forms a barrier with the second cup inner side wall when the first and second cups are nested together, the barrier inhibiting pill material located between the first and second cups from exiting from between the first and second cups when in the nested condition.

The pill cup assembly may include an embodiment wherein the flange is flexible.

The pill cup assembly may include an embodiment wherein the flange free edge has a diameter larger than a diameter of the first cup side wall inner surface whereby the flange flexes inwardly toward the first cup side wall under force applied thereagainst by the second cup side wall inner surface as the first and second cups are placed into the nested condition.

The pill cup assembly may include an embodiment wherein the second cup side wall tapers inwardly toward the center of the second cup as the second cup side wall extends toward the second cup bottom wall, and wherein the diameter of the flange free edge is greater than the smallest diameter of the second cup side wall segment such that the flange free edge will contact the second cup side wall segment as the first cup is advanced into and nested with the second cup.

The pill cup assembly may include an embodiment wherein the flange is rigid and the second cup side wall is flexible.

The pill cup assembly may include an embodiment wherein the flange free edge has a diameter smaller than the diameter of said upper perimeter edge of the second cup.

The pill cup assembly may include an embodiment wherein the flange free edge has a diameter substantially the same as the diameter of the upper perimeter edge of said second cup.

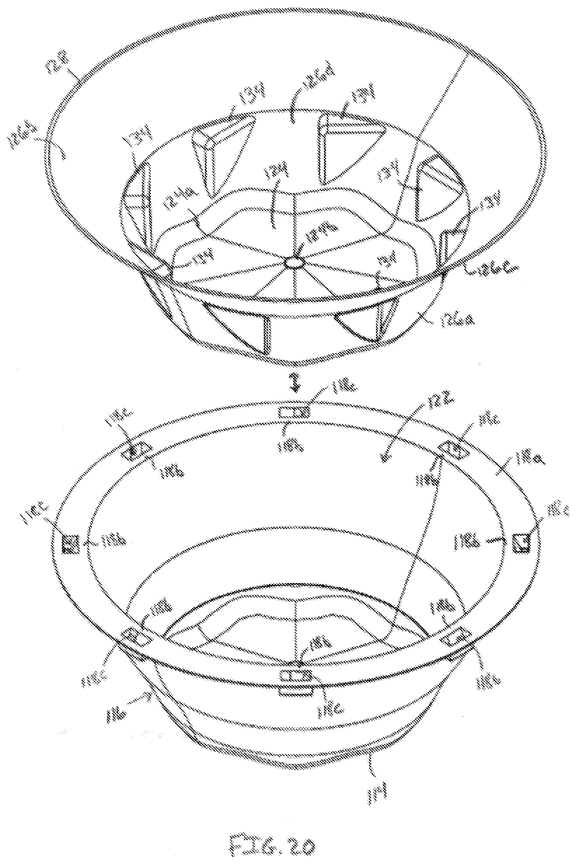

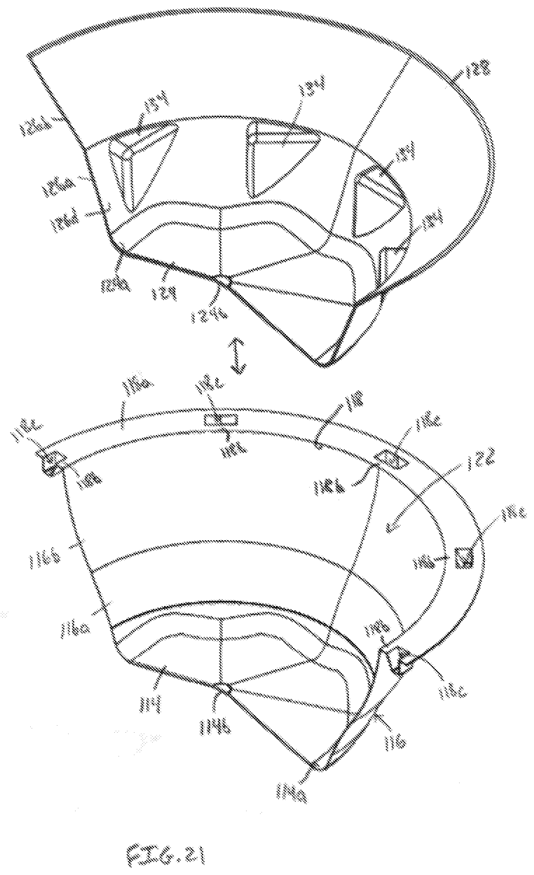

Turning now to FIGS. 19-21, there is seen an alternative embodiment of nestable top and bottom cups 110 and 112, respectively, for crushing one or more pills “P” placed therebetween .The pair of nestable cups 110 and 112 may be used manually but are preferably used with a pill crushing machine in which the cups may be removably placed with the machine operable to rotate one of the cups relative to the other cup to impart a grinding force on the one or more pills located therebetween. Cups 110, 112 are preferably disposable single use cups and formed of a suitable material such as metal or plastic, for example, which may be vacuum or thermo formed plastic, for example. In a preferred embodiment, top cup 110 and bottom cup 112 have different dimensions, with top cup 110 being generally smaller than bottom cup 112 so as to nest therein.

Referring now to bottom cup 112, bottom cup 112 includes a bottom wall 114 with an integral side wall 116 extending from the bottom wall 114 and terminating in an upper perimeter 118 defining an open top 120 having a diameter D2 leading to an open interior space 122. Bottom wall 14 may have a radial fluted configuration as seen in FIGS. 19-21 although other configurations are possible. The radial fluted configuration promotes crushing of the pill(s) “P” between the top and bottom cups due to the interrupted surface topography. The inner perimeter 114a is preferably curved to enable the leading edge of a spoon to be easily passed thereagainst in an uninterrupted manner so as to enable easy scooping out of essentially all of the powdered pill once mixed with the food additive to form a slurry/liquid to aid ingestion as discussed above. The center section 114b may be indented toward open top 120 so that the pill material tends to collect toward the perimeter 114a.

Side wall 116 may have one or more segments 116a and 116b which may be of differing dimensions. In the embodiment shown in FIGS. 19-21, a first segment 116a extends from bottom wall 114 a first width W6 and may curve inwardly as it extends in the direction toward open top 120. A second segment 116b may extend from first segment 116a and may taper outwardly for a second width W7. Upper perimeter 118 may include a flange 118a. Flange 118a may be substantially planar and lie along a plane which extends at an angle “A5” relative side wall second segment 116b. One or more recesses 118c may be formed in annularly spaced relation within flange 118a a spaced distance 118b from upper perimeter 118. Recesses 118c allow bottom cup 112 to be removably held by a cup holder having complimentary shaped and spaced projections while spaced distance 118b prevents powered pill material from exiting bottom cup 112 via a recess 118c.

Referring now to top cup 110, top cup 110 includes a bottom wall 124 with an integral side wall 126 extending from the bottom wall 124 and terminating in an upper perimeter 128 defining an open top 130 leading to an interior space 132. Bottom wall 124 may have a radial fluted configuration as seen in FIGS. 19-21, although other configurations are possible. The radial fluted configuration may be of complimentary configuration to bottom cup 112 bottom wall 114 with the outer surface of inner perimeter 124a preferably curved to closely follow the curve of the bottom cup inner perimeter 114a, and the center section 124b indented toward open top 130.

Side wall 126 may have one or more segments 126a and 126b which may be of differing dimensions. In the embodiment shown in FIGS. 19-21, a first segment 126a extends from bottom wall 124 a width W8 and may taper outwardly as it extends in the direction toward open top 30. A second segment 126b may extend from first segment 126a and may taper outwardly for a width W7. The angle of taper “A6” of first segment 126a relative to the horizontal plane defined by upper perimeter 128 may be greater than the angle of taper “A7” of second segment 126b relative to the horizontal plane defined by upper perimeter 128. Second segment 126b defines upper perimeter 128 having a diameter D3.

In one aspect of the invention, diameter D3 is selected to be greater than diameter D2 of upper perimeter 118 of bottom cup 112. Second segments 126b may be constructed of a flexible materials whereby outer surface 126c of second segment 126b may then engage upper perimeter 118 when top cup 110 is nested within bottom cup 112. Spaced distance 118b creates an uninterrupted upper perimeter 118 such that outer surface 126c forms an uninterrupted 360° seal against upper perimeter 118, thereby preventing unwanted loss of pill material from bottom cup 112 during crushing. In another aspect of the invention, the length of diameter D3 and angle A7 are selected such that outer surface 126c seats against upper perimeter 118 despite the size of pill(s) P placed within bottom cup 112 to be crushed.

One or more projections 134 may be formed in annularly spaced relation about the inner surface 116d of first segment 126a which allow top cup 10 to be removably held by a cup holder having complimentary drive members on the pill crushing machine where the projections 134 may engage with the drive members to assist rotation of top cup 110 against bottom cup 112 as described above.

The present invention may comprise a pill cup assembly adapted for grinding one or more pills into a powder, the pill cup assembly comprising:

a) first and second nestable cups each having a bottom wall with inner and outer surfaces and a side wall with inner and outer surfaces, each side wall extending from a respective said bottom wall and terminating in an upper perimeter edge defining an open top with an interior space;

b) a flange extending from the upper perimeter edge of the second cup, the flange defining a plurality of annularly spaced recesses located a spaced distance from the upper perimeter edge of the second cup;

wherein the first cup is nestable within said second cup with the side wall of the first cup locating within the second cup interior space and sealingly engaging the upper perimeter of the second cup when placed in the nested condition.

The pill cup assembly may include an embodiment wherein the first cup side wall and forms a barrier with the second cup inner side wall when the first and second cups are nested together, the barrier inhibiting pill material located between the first and second cups from exiting from between the first and second cups when in the nested condition.

The pill cup assembly may include an embodiment wherein the side wall of the first cup is flexible.

The pill cup assembly may include an embodiment wherein an upper portion of the side wall of the first cup a diameter larger than a diameter of the second cup upper perimeter whereby the upper portion of the side wall of the first cup flexes inwardly when under force applied thereagainst by the second cup side upper perimeter as the first and second cups are placed into the nested condition.

While the present apparatus and method has been shown and described with reference to certain preferred embodiments thereof, it will be understood by those skilled in the art that various changes in form and details may be made therein without departing from the spirit and scope of the invention as described.

What is claimed is:

1. A pill cup assembly adapted for grinding one or more pills into a powder, the pill cup assembly comprising:
a) first and second nestable cups each having a bottom wall with inner and outer surfaces and a side wall with inner and outer surfaces, each said side wall extending from a respective said bottom wall and terminating in an upper perimeter edge defining an open top with an interior space;
b) a flange extending from said upper perimeter edge of said first cup, said flange having an outer wall surface terminating in a free edge spaced from said top cup side wall;
wherein said first cup is nestable within said second cup with said flange free edge of said first cup locating within said second cup interior space when placed in the nested condition.

2. The pill cup assembly of claim 1 wherein said flange free edge contacts and forms a barrier with said second cup inner side wall when said first and second cups are nested together, said barrier inhibiting pill material located between said first and second cups from exiting from between said first and second cups when in the nested condition.

3. The pill cup assembly of claim 2 wherein said flange is flexible.

4. The pill cup assembly of claim 3 wherein said flange free edge has a diameter larger than a diameter of said first cup side wall inner surface whereby said flange flexes inwardly toward said first cup side wall under force applied thereagainst by said second cup side wall inner surface as said first and second cups are placed into the nested condition.

5. The pill cup assembly of claim 4 wherein said second cup side wall tapers inwardly toward the center of said second cup as said second cup side wall extends toward said second cup bottom wall, and wherein the diameter of said flange free edge is greater than the smallest diameter of said second cup side wall segment such that said flange free edge will contact said second cup side wall segment as said first cup is advanced into and nested with said second cup.

6. The pill cup assembly of claim 2 wherein said flange is rigid and said second cup side wall is flexible.

7. The pill cup assembly of claim 1 wherein said flange free edge has a diameter smaller than the diameter of said upper perimeter edge of said second cup.

8. The pill cup assembly of claim 1 wherein said flange free edge has a diameter substantially the same as the diameter of said upper perimeter edge of said second cup.

9. The pill cup assembly of claim 1 wherein said flange includes an inner wall surface facing and spaced from said top cup side wall outer surface.

10. The pill cup assembly of claim 1 wherein said flange is rigid and includes a shoulder extending between said free edge to said top cup side wall outer surface.

11. The pill cup assembly of claim 10 wherein said top pill cup is made from a metal material.

12. The pill cup assembly of claim 11 wherein said bottom cup is made from a plastic material.

13. The pill cup assembly of claim 1 wherein in one or both of said top and bottom cups are made from a metal material.

14. The pill cup assembly of claim 1 wherein one or both of said top and bottom cups are made from a plastic material.

15. A pill cup assembly adapted for grinding one or more pills into a powder, the pill cup assembly comprising:
a) first and second nestable cups each having a bottom wall with inner and outer surfaces and a side wall with inner and outer surfaces, each side wall extending from a respective said bottom wall and terminating in an upper perimeter edge defining an open top with an interior space;
b) a flange extending from the upper perimeter edge of the second cup, the flange defining a plurality of annularly spaced recesses located a spaced distance from the upper perimeter edge of the second cup;
wherein the first cup is nestable within said second cup with the side wall of the first cup locating within the second cup interior space and sealingly engaging the upper perimeter of the second cup when placed in the nested condition.

16. The pill cup assembly of clam 15 wherein the first cup side wall contacts and forms a barrier with the second cup inner side wall when the first and second cups are nested together, the barrier inhibiting pill material located between the first and second cups from exiting from between the first and second cups when in the nested condition.

17. The pill cup assembly of clam 15 wherein the side wall of the first cup is flexible.

18. The pill cup assembly of clam 15 wherein an upper portion of the side wall of the first cup a diameter larger than a diameter of the second cup upper perimeter whereby the upper portion of the side wall of the first cup flexes inwardly when under force applied thereagainst by the second cup side upper perimeter as the first and second cups are placed into the nested condition.
